(19) United States
(12) Patent Application Publication
(10) Pub. No.: US 2006/0125898 A1
(43) Pub. Date: Jun. 15, 2006

(54) Isochronous double sided ink jet printer

(76) Inventor: Jian Liang, Shenyang City (CN)

Correspondence Address: Eric Chan, 42 Pin Oaks Drive, Phoenixville, PA, 19460, US

(21) Appl. No.: 10/543,350

(22) PCT Filed: Feb. 13, 2004
(86) PCT No.: PCT/CN04/00121

§ 371 Date: Jul. 25, 2005

(30) Foreign Application Priority Data
Mar. 28, 2003 (CN) 03111299.4

(51) Int. Cl. B41J 2/01

(52) U.S. Cl. 347/104

(57) ABSTRACT

The present invention provides an isochronous double-sided ink jet printer, which can print on both sides of the lamp house material. Said printer comprises: supply roller motor, winding roller motor, guide beam, guide beam adjusting bracket, printing heads, front printing head carriage, back printing head carriage, printing material bearing band support rolls, printing material bearing band drive roll, home roll, frame etc. said home roll having central heating system is arranged on the upper portion of the frame. Said guide beam adjusting bracket is arranged on the right upper portion of the frame. Said guide beam is arranged on the guide beam adjusting bracket, and the flatness of the guide beam can be adjusted by the guide beam adjusting bracket. Said supply roller motor is arranged on the right central portion of the frame. Printing material bearing band is wrapped on both of the printing material bearing band support rolls and the printing material bearing band drive roll. Said printing material bearing band is pressed by the printing material pressing roll.

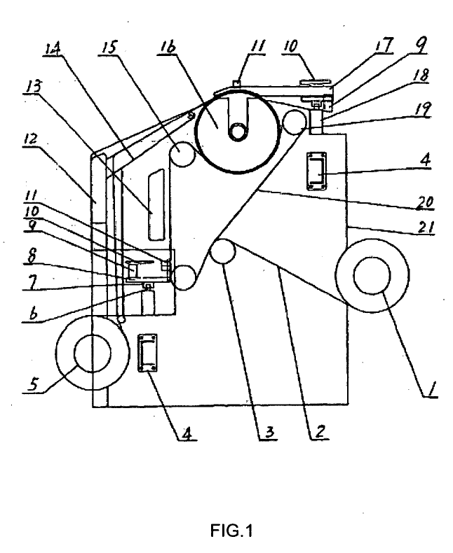

### BACKGROUND OF THE INVENTION

This invention involves a kind of high precision isochronous double-sided picture ink jet printer, which can print pictures on both obverse and reverse surfaces of the lamp house (illuminated advertisement) materials at the same time, and the method of picture jet printing.

With continuous development of modern civilization and the needs of commerce, and continuous improvement of the living standard of the people, the jet printing equipment is used more widely. This kind of equipment can be used in jet printing of design and color of textile products, jet printing of gigantic-sized street advertising board and jet printing of individualized pattern of flexible decorative material. But the present existing digital jet printing equipment usually prints one surface at first and then turns to another surface for jet printing, as well as it is required that the printed picture on the obverse surface must fit in perfectly the printed mirror symmetry picture on the reverse surface. Conventional technology is difficult to determine accurate position in the printing. The following point contact friction mode and line contact friction mode are basically adopted in the most equipment: the pressing out of multipoint rubber wheel and long rubber roll, pressing out of long rubber roll and long rubber roll and pressing out of small rubber wheel and small rubber roll. It is difficult for these modes to guarantee that the printed material has no dislocation, no deflection and no step loss during its movement. Furthermore, it is required for machine parts to have a high process precision and installation precision. Especially, when it is the following conditions: printing firstly on front surface of lamp house cloth and then printing the back surface of lamp house cloth; it is required that front-sided picture and back-sided picture are the same; and two operations can not have error, it is difficult for the modes mentioned above to guarantee the feed precision. In addition, there is a low efficiency in the printing method that one surface is printed at first and then another surface is printed, and it is required that the operator must be careful in order to guarantee no error in printing. Therefore, to develop a high precision isochronous double-sided picture ink jet printer has been being the new scientific research topic that has to be solved urgently at home and abroad.

### BRIEF SUMMARY OF THE INVENTION

The objective of this invention is realized by the following way: whole device comprises: cloth-supply and tension-applied roller motor, lamp house cloth, pressing-cloth roll, guide beam adjusting bracket, cloth-winding and tension-applied roller motor, guide, slider, back printing head carriage, ink supply system, circuit board, printing head, external air drying cover, internal air drying cover, lamp house, printing material bearing band support rolls, home roll, front printing head carriage, guide beam, printing material bearing band drive roll, printing material bearing band and machine frame. The home roll having central heating system is installed on the upper portion of the frame; the guide beam adjusting bracket is installed on the right upper portion of the frame; the guide beam is installed on the guide beam adjusting bracket, and the flatness of the guide beam can be adjusted by the guide beam adjusting bracket; the guide is installed on the guide beam; the slider is installed on the guide; the front printing head carriage that can slide on the guide is installed on the slider; the ink supply system, circuit board and printing heads that are arranged in the form of arc are installed on the front printing head carriage; the cloth-supply and tension-applied roller motor is installed on the right middle portion of the frame; the printing material bearing band support rolls, printing material bearing band drive roll and pressing-cloth roll that can move up and down are installed respectively on the middle and upper portions of the frame; the lamp house, internal air drying cover and external air drying cover are installed on the left upper portion of the frame; the guide beam adjusting bracket is installed on the left lower portion of the frame; the guide beam is installed on the guide beam adjusting bracket, and the flatness of the guide beam can be adjusted by the guide beam adjusting bracket; the guide is installed on the guide beam; the slider is installed on the guide; the back printing head carriage that can slide on the guide is installed on the slider; the ink supply system, circuit board and printing head are installed on the back printing head carriage; the cloth-winding and tension-applied roller motor, which can guarantee the backward tension the lamp house cloth has at any moment, is installed on the left lower portion of the frame; the printing material bearing band covers two printing material bearing band support rolls and printing material bearing band drive roll, and use the pressing-cloth roll, which can clamp the lamp house cloth and also tighten the printing material bearing band to make the home roll and printing material bearing band camp and feed the lamp house cloth, to press it tightly. The key point of this invention lies in the structural configuration of its product and the operating principle of double-sided jet printing. Its operating principle and mode of operation are as follows: place the lamp house cloth on the roll of cloth-supply and tension-applied roller motor, and then put the lamp house cloth to pass through the pressing-cloth roll and cling the printing material bearing band and wind round the printing material bearing band support rolls, then pass through the bottom of the home roll and enwind more than half a circle of the home roll, and then pass through the top surface of the lamp house to wind round the roller of cloth-winding and tension-applied roller motor. The back printing head carriage receives the data of back-sided picture and controls the printing head to jet the ink on the back-sided lamp house cloth. When the starting point for jet printing of lamp house cloth runs to the starting position of the jet printing of the front printing head carriage, the front printing head carriage receives the data of front-sided picture and controls the printing head to jet the ink on the front-sided lamp house cloth that winds round home roll. Because the every point of lamp house cloth runs synchronistically, there is no error between front-sided picture and back-sided picture in the aspect of stepping direction. In addition, because the drive motors of transverse front and back printing head carriage is controlled synchronistically, there is also no error between transverse front-sided picture and back-sided picture. The quantity of ink to be jetted on the back-sided surface is only 50% of the quantity of ink to be jetted on front-sided surface. The printed picture has been surface dry basically after drying through the internal air drying cover. The printed picture on the front-sided surface can be rolled up after heating by home roll and drying in the external air drying cover. The effect of printed picture can be observed directly on the lamp house. Comparing with present existing technology, the high precision isochronous double-sided picture ink jet printer has following characteristics: having unique concept design and scientific manufacturing process principle, and it can make the picture on the front-sided surface accurately fit in perfectly the mirror symmetry picture on the back-sided surface and have no error. Its production efficiency is twice and above as much as that of two-step double-sided jet printer. It will be widely used in the making of double-sided lamp house in the advertising industry.

### BRIEF DESCRIPTION OF THE DRAWINGS

The specific structure of this invention is given in the following example and attached figure:

### DETAILED DESCRIPTION OF THE INVENTION

Specific mode is as follows: See attached figure. Whole device comprises: cloth-supply and tension-applied roller motor 1, lamp house cloth 2, pressing-cloth roll 3, guide beam adjusting bracket 4, cloth-winding and tension-applied roller motor 5, guide 6, slider 7, back printing head carriage 8, ink supply system 9, circuit board 10, printing head 11, external air drying cover 12, internal air drying cover 13, lamp house 14, printing material bearing band support rolls 15, home roll 16, front printing head carriage 17, guide beam 18, printing material bearing band drive roll 19, printing material bearing band 20, and frame 21. The home roll 16 having central heating system is installed on the upper portion of the frame 21; the guide beam adjusting bracket 4 is installed on the right upper portion of the frame 21; the guide beam 18 is installed on the guide beam adjusting bracket 4, and the flatness of the guide beam 18 can be adjusted by the guide beam adjusting bracket 4; the guide 6 is installed on the guide beam 18; the slider 7 is installed on the guide 6; the front printing head carriage 17 that can slide on the guide 6 is installed on the slider 7; the ink supply system 9, circuit board 10 and printing heads 11 that are arranged in the form of arc are installed on the front printing head carriage 17; the cloth-supply and tension-applied roller motor 1 is installed on the right middle portion of the frame 21; the printing material bearing band support rolls 15, printing material bearing band drive roll 19 and pressing-cloth roll 3 that can move up and down are installed respectively on the middle and upper portions of the frame 21; the lamp house 14, internal air drying cover 13 and external air drying cover 12 are installed on the left upper portion of the frame 21; the guide beam adjusting bracket 4 is installed on the left lower portion of the frame 21; the guide beam 18 is installed on the guide beam adjusting bracket 4, and the flatness of the guide beam 18 can be adjusted by the guide beam adjusting bracket 4; the guide 6 is installed on the guide beam 18; the slider 7 is installed on the guide 6; the back printing head carriage 8 is installed, which can slide on the guide 6, on the slider 7; the ink supply system 9, circuit board 10 and printing head 11 are installed on the back printing head carriage 8; the cloth-winding and tension-applied roller motor 5, which can guarantee the backward tension the lamp house cloth 2 has at any moment, is installed on the left lower portion of the frame 21; the printing material bearing band 20 covers two printing material bearing band support rolls 15 and printing material bearing band drive roll 19, and use the pressing-cloth roll 3, which can clamp the lamp house cloth 2 and also tighten the printing material bearing band 20 to make the home roll 16 and printing material bearing band 20 camp and feed the lamp house cloth 2, to press it tightly.

What is claimed is:

1. A kind of high precision isochronous double-sided picture ink jet printer, whole device comprises: cloth-supply and tension-applied roller motor, lamp house cloth, pressing-cloth roll, guide beam adjusting bracket, cloth-winding and tension-applied roller motor, guide, slider, back printing head carriage, ink supply system, circuit board, printing head, external air drying cover, internal air drying cover, lamp house, printing material bearing band support rolls, home roll, front printing head carriage, guide beam, printing material bearing band drive roll, printing material bearing band and frame; the home roll having central heating system is installed on the upper portion of the frame; the guide beam adjusting bracket is installed on the right upper portion of the frame; the guide beam is installed on the guide beam adjusting bracket, and the flatness of the guide beam can be adjusted by the guide beam adjusting bracket; the guide is installed on the guide beam; the slider is installed on the guide; the front printing head carriage that can slide on the guide is installed on the slider; the ink supply system, circuit board and printing head that are arranged in the form of arc are installed on the front printing head carriage; the cloth-supply and tension-applied roller motor is installed on the right middle portion of the frame; the printing material bearing band support rolls, printing material bearing band drive roll and pressing-cloth roll that can move up and down are installed respectively on the middle and upper portions of the frame; the lamp house, internal air drying cover and external air drying cover are installed on the left upper portion of the frame; the guide beam adjusting bracket is installed on the left lower portion of the frame; the guide beam is installed on the guide beam adjusting bracket, and the flatness of the guide beam can be adjusted by the guide beam adjusting bracket; the guide is installed on the guide beam; the slider is installed on the guide; the back printing head carriage is installed, which can slide on the guide, on the slider; the ink supply system, circuit board and printing head are installed on the back printing head carriage; the cloth-winding and tension-applied roller motor, which can guarantee the backward tension the lamp house cloth has at any moment, is installed on the left lower portion of the frame; the printing material bearing band covers two printing material bearing band support rolls and printing material bearing band drive roll, and use the pressing-cloth roll, which can clamp the lamp house cloth and also tighten the printing material bearing band to make the home roll and printing material bearing band camp and feed the lamp house cloth, to press it tightly.
